(19) United States
(12) Patent Application Publication
(10) Pub. No.: US 2026/0245821 A1
(43) Pub. Date: Aug. 20, 2026

(54) ELECTROMAGNETIC RELAY

(71) Applicant: OMRON Corporation, Kyoto-shi, Kyoto (JP)

(72) Inventor: Naoki KAWAGUCHI, Kyoto-shi, Kyoto (JP)

(21) Appl. No.: 19/159,326

(22) PCT Filed: Feb. 20, 2024
(86) PCT No.: PCT/JP2024/006052

§ 371 Date: Aug. 25, 2025

(30) Foreign Application Priority Data
Mar. 13, 2023 (JP) 2023-038894

(51) Int. Cl. H01H 50/54; H01H 50/02; H01H 50/12

(52) U.S. Cl. CPC H01H 50/546; H01H 50/02; H01H 50/12

(57) ABSTRACT

An electromagnetic relay includes a case, a drive device, a contact device, a conductive member, and a heat-receiving member. The drive device is disposed inside the case. The contact device is disposed adjacent to the drive device inside the case. The conductive member is connected to the contact device inside the case. The heat-receiving member is disposed inside the case. The heat-receiving member contacts at least a portion of the conductive member and receives heat from the conductive member.

### CROSS-REFERENCE TO RELATED APPLICATION

This application is the U.S. National Phase of International Application No. PCT/JP2024/006052, filed on Feb. 20, 2024. This application claims priority to Japanese Patent Application No. 2023-038894, filed on Mar. 13, 2023. The contents of those applications are incorporated by reference herein in their entireties.

### TECHNICAL FIELD

The claimed invention relates to an electromagnetic relay.

### BACKGROUND ART

An electromagnetic relay disclosed in Japanese Patent No. 7,117,567 includes a drive device, a movable plate, a contact device, and a conductive member. In this case, when the movable plate and a fixed terminal of the contact device contact each other, heat is generated by contact resistance. This heat is transferred from the fixed terminal of the contact device to the conductive member and is dissipated from the conductive member. This reduces the temperature of the heat transferred to the movable plate and the contact device.

### SUMMARY

In the conventional electromagnetic relay, the drive device, the movable plate, the contact device, and the conductive member are covered by the case. Therefore, the heat dissipated from the conductive member causes temperature of the air inside the case, i.e., the temperature inside the case, to rise. Here, an exterior surface of the case may be cooled to lower the temperature of the air inside the case. However, when high-temperature heat is transferred from the conductive member to the air inside the case, it is difficult to prevent the temperature inside the case from rising.

An object of the present invention is to provide an electromagnetic relay that can suppress a temperature rise inside the case by transferring heat from a conductive member to a case.

### Solution to Problems

An electromagnetic relay according to one aspect of the claimed invention includes a case, a drive device, a contact device, a conductive member, and a heat-receiving member. The drive device is disposed inside the case. The contact device is disposed adjacent to the drive device inside the case. The conductive member is connected to a contact device inside the case. The heat-receiving member is disposed inside the case. The heat-receiving member contacts at least a portion of the conductive member and receives heat from the conductive member.

In the electromagnetic relay, the heat-receiving member contacts at least a portion of the conductive member inside the case so that the heat from the conductive member can be transferred to the case via the heat-receiving member. This configuration suitably prevents the temperature inside the case from rising.

The conductive member can include a current-carrying portion and a heat-dissipating portion. In this case, the current-carrying portion is disposed between the case and the contact device. The heat-dissipating portion is provided on the current-carrying portion. The heat-dissipating portion is disposed between the case and the drive device. The heat-receiving member contacts at least a portion of the heat-dissipating portion.

In this configuration, a current path of the conductive member is secured by the current-carrying portion, and the heat of the conductive member can be suitably transferred from the heat-dissipating portion to the heat-receiving member.

The conductive member can include a current-carrying portion. In this case, the current-carrying portion is disposed between the case and the contact device. The heat-receiving member contacts at least a portion of the current-carrying portion. The heat-receiving member can further contact at least a portion of the contact device. The contact device can include a terminal portion that is connected to the conductive member. In this case, the heat-receiving member contacts at least a portion of the terminal portion.

In this configuration, the heat-receiving member contacts at least a portion of the current-carrying portion of the conductive member and at least a portion of the contact device so that the heat of the conductive member and the heat of the contact device can be transferred to the case via the heat-receiving member. In addition, the heat-receiving member contacts at least a portion of the terminal portion, the heat of the conductive member and the heat of the terminal portion of the contact device can be more suitably transferred to the case via the heat-receiving member.

The heat-receiving member can be filled inside the case so as to contact at least a portion of the conductive member. In this configuration, the heat of the conductive member can be more suitably transferred to the case via the heat-receiving member. This configuration suitably prevents the temperature inside the case from rising.

According to the present invention, a temperature rise inside the case is suppressed by suitably transferring heat from a conductive member to a case in an electromagnetic relay.

### BRIEF DESCRIPTION OF THE DRAWINGS

FIG. 1 is a perspective view of an electromagnetic relay in accordance with the claimed invention.

FIG. 2 is a front view of the electromagnetic relay.

FIG. 3A is a perspective view of a first conductive member.

FIG. 3B is a perspective view of a second conductive member.

FIG. 4 is a perspective view of an electromagnetic relay according to a first modified example.

FIG. 5 is a perspective view of an electromagnetic relay according to a second modified example.

### DETAILED DESCRIPTION

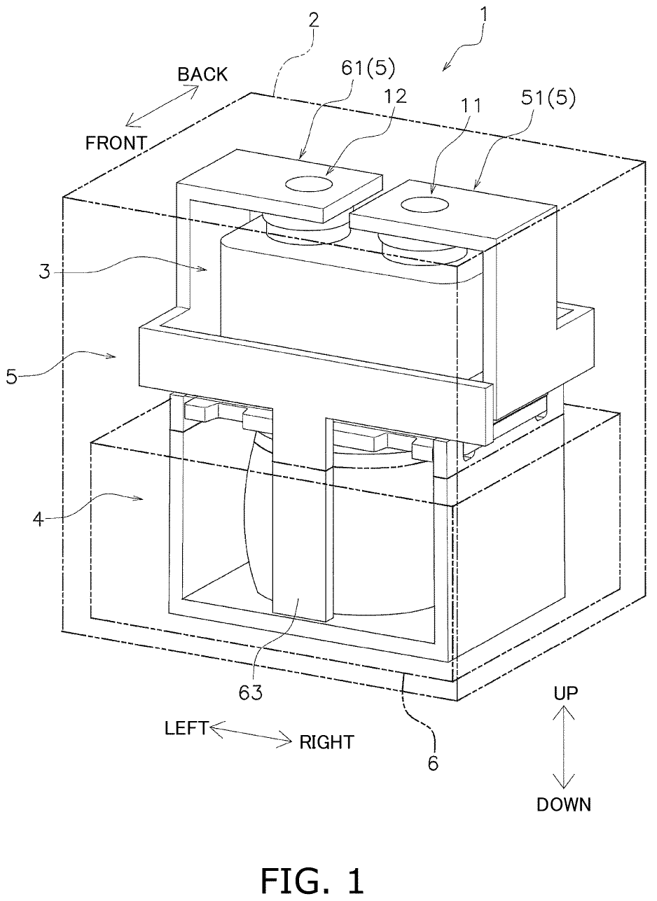

Hereinafter, an exemplary embodiment of an electromagnetic relay 1 accordance with the claimed invention will be described with reference to the drawings. As shown in FIG. 1, the electromagnetic relay 1 includes a case 2, a contact device 3, a drive device 4, a conductive member 5, and a heat-receiving member 6. In the following description, a direction in which the contact device 3 and the drive device 4 are disposed with respect to the bottom of the case 2 is defined as an upward direction. The opposite direction to the upward direction is defined as a downward direction.

A direction in which a first fixed terminal 11 and a second fixed terminal 12, which is described later, are disposed side by side is defined as a left-right direction. A direction perpendicular to the left-right direction and a vertical direction is defined as a front-back direction. These directions are defined for the convenience of explanation and do not limit an arrangement direction of the electromagnetic relay 1.

As shown in FIG. 1, the case 2 is formed in a box shape. The case 2 is made of an insulating material such as resin. The case 2 accommodates the contact device 3 and the drive device 4. The contact device 3 is disposed adjacent to the drive device 4 inside the case 2. For example, the contact device 3 is disposed above the drive device 4 inside the case 2.

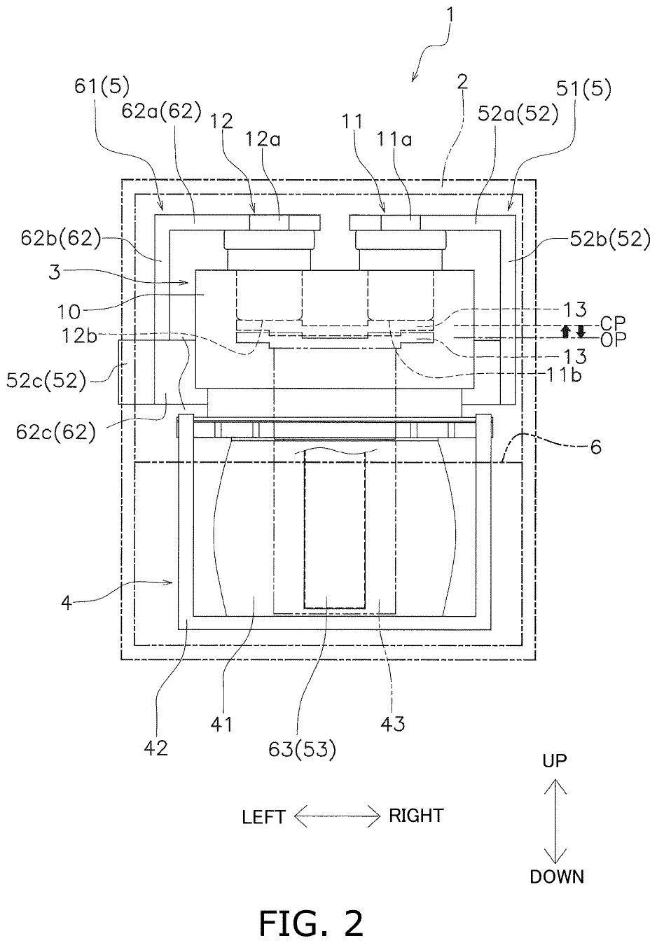

As shown in FIG. 2, the contact device 3 includes a contact case 10, the first fixed terminal 11, the second fixed terminal 12, and a movable contact piece 13. The contact case 10 is disposed inside the case 2. The contact case 10 is disposed on an upper portion of the drive device 4. The first fixed terminal 11, the second fixed terminal 12, and the movable contact piece 13 are disposed in the contact case 10.

The first and second fixed terminals 11, 12 are terminals for connecting an external circuit. The first and second fixed terminals 11, 12 are made of a conductive material such as copper or a copper alloy. The conductive material can be a material other than copper or a copper alloy.

The first and second fixed terminals 11, 12 are disposed at an interval from each other. For example, the first and second fixed terminals 11, 12 are disposed at an interval in the left-right direction. The first and second fixed terminals 11, 12 are supported by the contact case 10.

The first and second fixed terminals 11, 12 are formed in a substantially cylindrical shape. Upper ends 11a and 12a of the first and second fixed terminals 11, 12 protrude from an upper surface of the contact case 10. The upper end 11a of the first fixed terminal 11 is connected to a first conductive member 51, which will be described later. The upper end 12a of the second fixed terminal 12 is connected to a second conductive member 61, which will be described later.

The movable contact piece 13 is a plate-like terminal that is long in one direction. The movable contact piece 13 is made of a conductive material such as copper or a copper alloy. The conductive material can be a material other than copper or a copper alloy.

The movable contact piece 13 is disposed below the first and second fixed terminals 11, 12. The movable contact piece 13 is disposed below the first and second fixed terminals 11, 12 so as to face the first and second fixed terminals 11, 12.

As shown in FIG. 2, the drive device 4 moves the movable contact piece 13. For example, the drive device 4 moves the movable contact piece 13 in the vertical direction. Specifically, the drive device 4 moves the movable contact piece 13 between a closed position CP in which the movable contact piece 13 contacts the lower ends 11b, 12b of the first and second fixed terminals 11, 12, and an open position OP in which the movable contact piece 13 is moved away from the first and second fixed terminals 11, 12. In FIG. 2, the movable contact piece 13 positioning at the closed position CP is indicated by a dashed line, and the movable contact piece 13 positioning at the open position OP is indicated by a two-dot dashed line.

The drive device 4 is disposed inside the case 2. The drive device 4 is disposed below the movable contact piece 13. The drive device 4 includes a coil 41 and a yoke 42. The coil 41 is disposed below the movable contact piece 13.

The movable contact piece 13 is disposed on the open position OP or the closed position CP by switching a voltage application state applied to the coil 41. For example, when no voltage is applied to the coil 41, the movable contact piece 13 is disposed in the open position OP by a return structure (not shown) of a moving structure 43. In this state, the first and second fixed terminals 11, 12 are not electrically connected.

When a voltage is applied to the coil 41, a magnetic field is generated around the coil 41. This magnetic field activates a magnetic attraction structure of the moving structure 43, and the movable contact piece 13 moves from the open position OP to the closed position CP. As a result, the movable contact piece 13 abuts the first and second fixed terminals 11, 12. In this state, the first and second fixed terminals 11, 12 are electrically connected via the movable contact piece 13.

The detailed description of the configuration of the moving structure 43 (the return structure and the magnetic attraction structure) is omitted, since the configuration of the moving structure 43 (the return structure and the magnetic attraction structure) is the same as the configuration of conventional technology.

As shown in FIG. 2, the yoke 42 is disposed between the coil 41 and the case 2. The yoke 42 is disposed so as to surround the coil 41. For example, the yoke 42 includes a shape that is bent into a C-shape. The yoke 42 is disposed so as to surround a lower surface of the coil 41, both side surfaces of the coil 41, and an upper surface of the yoke 42.

As shown in FIGS. 1 and 2, the conductive member 5 is connected to the contact device 3 inside the case 2. The conductive member 5 includes the first conductive member 51 and the second conductive member 61. The first and second conductive members 51, 61 are made of a conductive material such as copper or a copper alloy. The conductive material can be a material other than copper or a copper alloy. The first and second conductive members 51, 61 are formed by bending a strip-shaped metal plate.

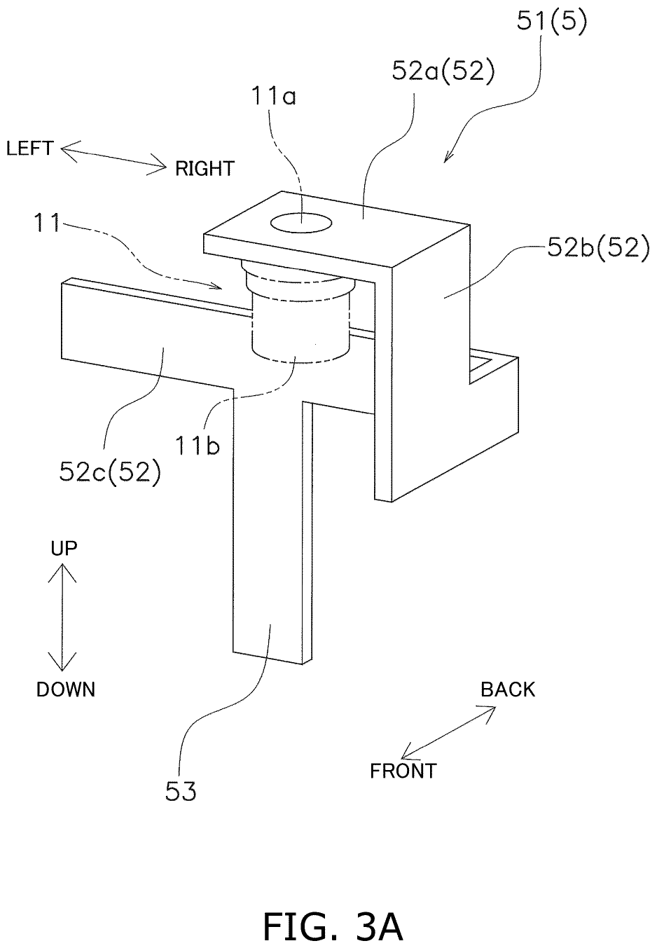

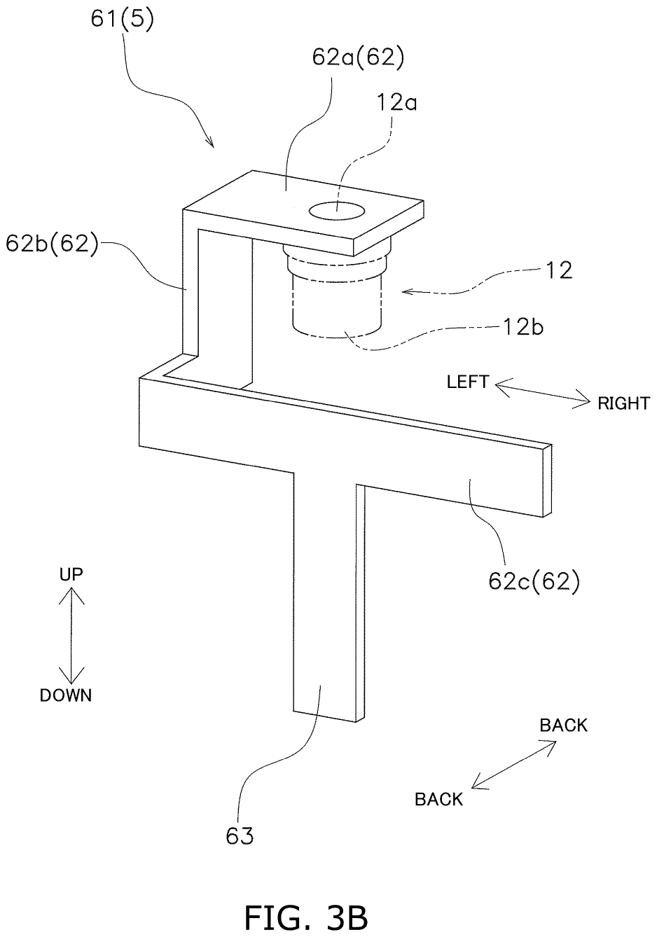

As shown in FIG. 3A, the first conductive member 51 includes a first current-carrying portion 52 (an example of a current-carrying portion) and a first heat-dissipating portion 53 (an example of a heat-dissipating portion). The first current-carrying portion 52 is disposed between the case 2 and the contact device 3. The first current-carrying portion 52 is connected to the contact device 3 and forms a current path. For example, the first current-carrying portion 52 is connected to the first fixed terminal 11.

As shown in FIG. 3A, the first current-carrying portion 52 includes a first connection portion 52a, a first extension portion 52b, and a first electric-path portion 52c. The first connection portion 52a, the first extension portion 52b, and the first electric-path portion 52c form the current path.

As shown in FIGS. 2 and 3A, one end of the first connection portion 52a is connected to the upper end 11a of the first fixed terminal 11. The first connection portion 52a extends in a direction from the second fixed terminal 12 toward the first fixed terminal 11, for example, on the right side away from the first fixed terminal 11.

The first extension portion 52b is disposed so as to face a right side wall of the case 2. The first extension portion 52b extends from the other end of the first connection portion 52a along a side portion of the first fixed terminal 11. For example, one end of the first extension portion 52b is connected to the other end of the first connection portion 52a. In this state, the first extension portion 52b extends from the other end of the first connection portion 52a to the a down side along the side portion of the first fixed terminal 11. More specifically, the first extension portion 52b further extends rearward after the first extension portion 52b extends from the other end of the first connection portion 52a to the down side along the side portion of the first fixed terminal 11.

The first electric-path portion 52c is disposed so as to face a rear wall of the case 2. The first electric-path portion 52c extends from the other end of the first extension portion 52b in the left-right direction. For example, the first electric-path portion 52c extends from the other end of the first extension portion 52b to a left side. As shown in FIG. 2, the first electric-path portion 52c passes behind the contact device 3, for example, behind the contact case 10. In a state where the movable contact piece 13 is disposed on the closed position CP, the first electric-path portion 52c is disposed between the movable contact piece 13 and the yoke 42 in the vertical direction.

As shown in FIG. 3A, the first heat-dissipating portion 53 is provided on the first current-carrying portion 52. Specifically, the first heat-dissipating portion 53 is provided on the first current-carrying portion 52 so as to be out of the current path of the first current-carrying portion 52.

In this embodiment, the first heat-dissipating portion 53 is provided on a lower portion of the first electric-path portion 52c. The first heat-dissipating portion 53 extends from the lower portion of the first electric-path portion 52c to the down side. The first heat-dissipating portion 53 is disposed between the case 2 and the drive device 4. For example, as shown in FIG. 2, the first heat-dissipating portion 53 is disposed between the rear wall of the case 2 and the coil 41.

As shown in FIG. 3A, the first heat-dissipating portion 53 is formed integrally with the first electric-path portion 52c. The first heat-dissipating portion 53 can be formed separately from the first electric-path portion 52c. In this case, the first heat-dissipating portion 53 is attached to the first electric-path portion 52c as a separate member.

As shown in FIG. 3B, the second conductive member 61 includes a second current-carrying portion 62 (an example of a current-carrying portion) and a second heat-dissipating portion 63 (an example of a heat-dissipating portion). The second current-carrying portion 62 includes a second connection portion 62a, a second extension portion 62b, and a second electric-path portion 62c.

The configuration of the second conductive member 61 is substantially the same as the configuration of the first conductive member 51, except for the arrangement of the second conductive member 61. For example, the configuration of second conductive member 61 can be understood by replacing “first” with “second” and replacing “right” with “left” in the above description of the first conductive member 51.

Therefore, the configuration of the second conductive member 61 is briefly described. As shown in FIG. 3B, the second connection portion 62a extends in a direction from the first fixed terminal 11 toward the second fixed terminal 12, for example, to the left side away from the second fixed terminal 12. The second extension portion 62b further extends forward after the second extension portion 62b extends from the second connection portion 62a to the down side along the side portion of the second fixed terminal 12.

As shown in FIGS. 1 and 2, the second electric-path portion 62c passes in front of the contact device 3, for example, in front of the contact case 10. The second heat-dissipating portion 63 is disposed between the case 2 and the drive device 4. For example, as shown in FIG. 2, the second heat-dissipating portion 63 is disposed between a front wall of the case 2 and the coil 41.

As shown in FIGS. 1 and 2, the heat-receiving member 6 contacts at least a portion of the conductive member 5 and receives heat from the conductive member 5. In this embodiment, the heat-receiving member 6 contacts a portion of the conductive member 5 and receives the heat from the conductive member 5. The heat-receiving member 6 is disposed inside the case 2.

For example, the heat-receiving member 6 is made of polyurethane. The heat-receiving member 6 can be made of other materials as long as the heat-receiving member 6 can absorb the heat from the conductive member 5. For example, the heat-receiving member 6 can be made of a synthetic resin such as an epoxy resin.

The heat-receiving member 6 is filled inside the case 2 so as to contact at least a portion of the conductive member 5. The heat-receiving member 6 is filled between the case 2 and the drive device 4. For example, as shown in FIG. 2, the heat-receiving member 6 is filled between the case 2 and the coil 41 so as to contact the first heat-dissipating portion 53 and the second heat-dissipating portion 63 of the conductive member 5.

Specifically, in a state where the first heat-dissipating portion 53 and the second heat-dissipating portion 63 are disposed between the case 2 and the coil 41, the heat-receiving member 6 is filled between the case 2 and the coil 41. In other words, an outer surface of the first heat-dissipating portion 53 and an outer surface of the second heat-dissipating portion 63 contact the heat-receiving member 6 by filling the heat-receiving member 6 between the case 2 and the coil 41. As a result, the heat-receiving member 6 absorbs the heat from the first heat-dissipating portion 53 and the second heat-dissipating portion 63, and the heat of the heat-receiving member 6 is transferred to the case 2.

In the above-mentioned electromagnetic relay 1, the heat-receiving member 6 contacts the first heat-dissipating portion 53 of the first conductive member 51 and the second heat-dissipating portion 63 of the second conductive member 61 inside the case 2 so that the heat of the first and second conductive members 51, 61 can be transferred to the case 2 via the heat-receiving member 6.

The first and second heat-dissipating portions 53, 63 are out of the current path of the first current-carrying portion 52 so that the current paths of the first and second conductive members 51, 61 are secured by the first and second current-carrying portions 52, 62, and the heat of the first and second conductive members 51, 61 can be transferred to the case 2 via the heat-receiving member 6. With this configuration, the electromagnetic relay 1 can suitably suppress a temperature rise inside the case 2.

One embodiment of the present invention has been described above, the present invention is not limited to the above embodiment, and various modifications can be performed without departing from the gist of the invention.

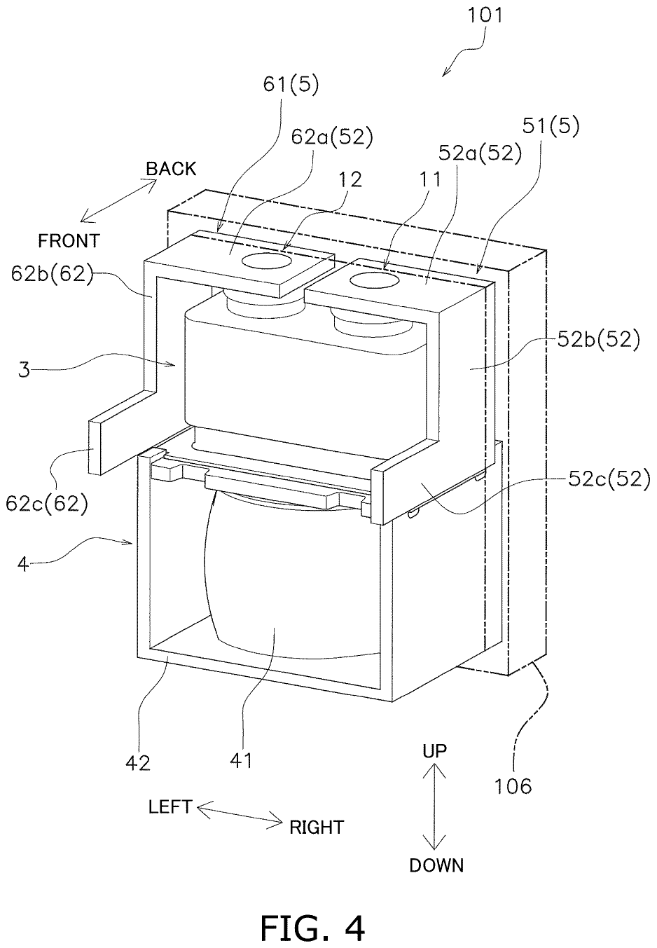

In the above embodiment, an example in which the heat-receiving member 6 contacts the first and second heat-dissipating portions 53, 63 of the first and second conductive members 51, 61 has been shown. The electromagnetic relay 101 can be configured as shown in a first modified example of FIG. 4, the case 2 is omitted for clarity.

In this case, as shown in FIG. 4, the first and second conductive members 51, 61 respectively include the first and second current-carrying portions 52, 62. The first and second current-carrying portions 52, 62 respectively include the first and second connection portions 52a, 62a, the first and second extension portions 52b, 62b, and the first and second electric-path portions 52c, 62c extending from the first and second extension portions 52b, 62b to a front side.

The heat-receiving member 106 is filled on the rear wall side of the case 2. For example, the heat-receiving member 106 contacts a rear portion of the coil 41 and covers the rear portion of the coil 41 and a rear portion of the yoke 42. The heat-receiving member 106 contacts the first and second current-carrying portions 52, 62. For example, the heat-receiving member 106 contacts a rear portion of the first connection portion 52a and a rear portion of the first extension portion 52b, and covers the rear portion of the first connection portion 52a and the rear portion of the first extension portion 52b. The heat-receiving member 106 contacts a rear portion of the second connection portion 62a and a rear portion of the second extension portion 62b, and covers the rear portion of the second connection portion 62a and the rear portion of the second extension portion 62b.

Thus, in the electromagnetic relay 101, the heat-receiving member 106 contacts the rear portions of the first and second current-carrying portions 52, 62 inside the case 2 so that the heat of the first and second conductive members 51, 61 can be transferred to the case 2 via the heat-receiving member 106. With this configuration, the electromagnetic relay 101 can suitably suppress a temperature rise inside the case 2.

In the first modified example, an example, in which the heat-receiving member 106 contacts the rear portions of the first and second current-carrying portions 52, 62, is shown. The heat-receiving member 106 can further contact the first and second fixed terminals 11, 12 and cover the first and second fixed terminals 11, 12. With this configuration, the temperature rise inside the case 2 is more suitably suppressed.

In the first modified example, the first and second conductive members 51, 61 do not include the first and second heat-dissipating portions 53, 63 of the above embodiment. For example, the first and second heat-dissipating portions 53, 63 of the above embodiment can be provided on the first and second connection portions 52a, 62a. As a result, the contact area between the heat-receiving member 106 and the first and second conductive members 51, 61 can be increased, and a temperature rise inside the case 2 is more suitably suppressed.

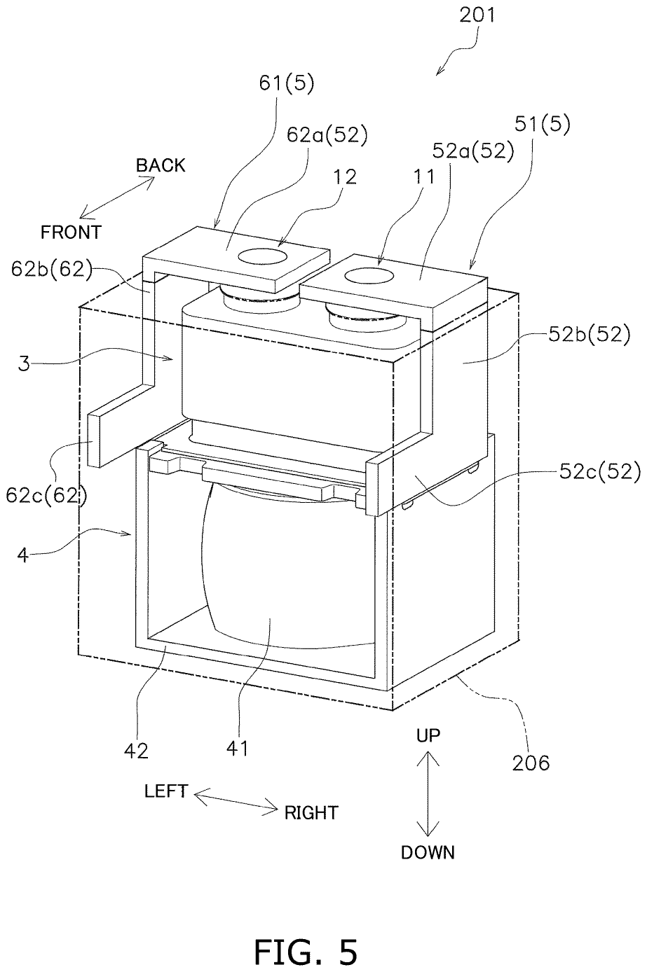

The electromagnetic relay 201 can be configured as shown in a second modified example of FIG. 5. In this case, the heat-receiving member 206 contacts the drive device 4, the contact device 3, and the conductive member 5. For example, the heat-receiving member 206 entirely contacts the drive device 4 and partially contact the contact device 3 and the conductive member 5.

Specifically, the heat-receiving member 206 entirely covers the coil 41, the yoke 42, and the contact case 10. The heat-receiving member 206 partially covers the first and second extension portions 52b, 62b of the first and second conductive members 51, 61, the first and second electric-path portions 52c, 62c, and the first and second fixed terminals 11, 12. The heat-receiving member 206 can entirely cover the first and second extension portions 52b, 62b of the first and second conductive members 51, 61, the first and second electric-path portions 52c, 62c, and the first and second fixed terminals 11, 12.

Thus, the heat-receiving member 206 contacts the first and second current-carrying portions 52, 62 and the first and second fixed terminals 11, 12 inside the case 2 in the electromagnetic relay 201 so that the heat of the first and second conductive members 51, 61 can be transferred to the case 2 via the heat-receiving member 206. With this configuration, the electromagnetic relay 201 can suitably suppress a temperature rise inside the case 2.

In the above-described embodiment and the modified examples, the electromagnetic relays 1, 101, 201 are used in a vertical orientation. However, the electromagnetic relays 1, 101, 201 can be used in a horizontal orientation.

### REFERENCE SIGNS LIST

1 Electromagnetic relay
2 Case
3 Contact device
4 Drive device
5 Conductive member
11 First fixed terminal
12 Second fixed terminal
13 Movable contact piece
41 Coil
42 York
51 First conductive member
52 First current-carrying portion
52a First connection portion
52b First extension portion
52c First electric-path portion
61 Second conductive member
62 Second current-carrying portion
62a Second connection portion
62b Second extension portion
62c Second electric-path portion
6, 106, 206; Heat-receiving member

1. An electromagnetic relay comprising:
a case
a drive device disposed inside the case;
a contact device disposed adjacent to the drive device inside the case;
a conductive member connected to the contact device inside the case; and
a heat-receiving member disposed inside the case, contacting at least a portion of the conductive member, and receiving heat from the conductive member.

2. The electromagnetic relay according to claim 1, wherein
the conductive member includes a current-carrying portion which is disposed between the case and the contact device, and a heat-dissipating portion which is provided on the current-carrying portion and disposed between the case and the drive device, and the heat-receiving member contacts at least a portion of the heat-dissipating portion.

3. The electromagnetic relay according to claim 1, wherein
the conductive member includes a current-carrying portion which is disposed between the case and the contact device, and
the heat-receiving member contacts at least a portion of the current-carrying portion.

4. electromagnetic relay according to claim 3, wherein
the heat-receiving member further contacts at least a portion of the contact device.

5. The electromagnetic relay according to claim 4, wherein
the contact device includes a terminal portion which is connected to the conductive member, and
the heat-receiving member contacts at least a portion of the terminal portion.

6. The electromagnetic relay according to claim 1, wherein
the heat-receiving member is filled inside the case se as to contact at least a portion of the conductive member.
